(19) United States
(12) Patent Application Publication
(10) Pub. No.: US 2013/0007215 A1
(43) Pub. Date: Jan. 3, 2013

(54) METHOD FOR SENDING PROMPT INFORMATION AND TERMINAL

(76) Inventor: Tao Xue, Shenzhen (CN)

(21) Appl. No.: 13/635,291

(22) PCT Filed: Jun. 10, 2010
(86) PCT No.: PCT/CN10/73759

§ 371 Date: Sep. 14, 2012

(30) Foreign Application Priority Data
Mar. 25, 2010 (CN) 201010140437.7

(51) Int. Cl. G06F 15/16

(52) U.S. Cl. 709/217

(57) ABSTRACT

Disclosed in the present invention is a method for transmitting prompt information and a terminal, which method comprises: a first terminal and a second terminal establishing communication; the first terminal acquiring a language type currently used by the second terminal; and the first terminal selecting a corresponding prompt information according to the language type and transmitting the prompt information to the second terminal. By virtue of the present invention, a corresponding prompt information can be selected according to the language type of a peer to prompt the peer during communications such as videophone and so on, which greatly improves the availability of the terminal and the user experience.

### FIELD OF THE INVENTION

The present invention relates to the communication field, and in particular to a method for sending prompt information and a terminal.

### BACKGROUND OF THE INVENTION

Videophone belongs to the scope of multimedia communication and is a video communication conference system with extensive application field, and people can view the image of the peer during communication. It is not only suitable for household life and also can be extensively applied in various fields of different industries such as diverse business activities, remote education, confidential monitoring, hospital nursing, medical diagnosis, scientific expedition and so on, therefore it has extremely broad market prospect.

During currently available videophone call, the following usage scenario often occurs: before recording the peer video, it often needs to prompt the peer that the peer video will soon be recorded. Currently available prompt method is to prompt the peer that the video will soon be recorded by sending a frame of image with prompt text picture to the peer and also to prompt that the recording is finished by sending a frame of image with prompt text picture to the peer when the recording is ended.

The inventors have found that in the above scenario, if the language modes of the calling and called terminals are inconsistent, it will cause the peer unable to understand the meaning of the prompt information when displaying the prompt information to the peer during the videophone call, so the user experience is not good.

### SUMMARY OF THE INVENTION

The present invention provides a method for sending prompt information and a terminal to at least solve the above problem.

A method for sending prompt information is provided according to one aspect of the present invention.

The method for sending prompt information according to the present invention comprises: a first terminal and a second terminal establishing communication; the first terminal acquiring a language type currently used by the second terminal; and the first terminal selecting corresponding prompt information according to the language type and sending the prompt information to the second terminal.

Preferably, before the first terminal acquiring the language type currently used by the second terminal, the above method further comprises: the first terminal presetting prompt information of all the language types; or a user of the first terminal inputting the prompt information of all the language types into the first terminal.

Preferably, the first terminal acquiring the language type of the second terminal comprises: the first terminal sending a language type request message for requesting the language type and receiving a language type message carrying the language type sent by the second terminal in responsive to the language type request message; and the first terminal receiving the language type message carrying the language type actively sent by the second terminal.

Preferably, after the first terminal sending a language type request message, the above method further comprises: the first terminal resending the language type request message in the situation that the language type message is not received within a preset time period.

Preferably, after the first terminal receiving the language type message, the above method further comprises: the first terminal sending to the second terminal an acknowledge language message for acknowledging that the language type message is received.

Preferably, the language type request message, the language type message and the acknowledge language message are implemented by the H.245 protocol.

A terminal is provided according to another aspect of the present invention.

The terminal according to the present invention comprises: an acquiring module, configured to acquire a language type currently used by a communication peer; a selecting module, configured to select corresponding prompt information according to the language type; and a sending module, configured to send the prompt information to the communication peer.

Preferably, the above terminal further comprises: a configuring module, configured to preset prompt information of all the language types; and the configuring module comprises: an input sub-module, configured to input the prompt information of all the language types.

Preferably, the acquiring module comprises: a sending sub-module, configured to send a language type request message for requesting the language type; and a receiving sub-module, configured to receive a language type message carrying the language type sent by the communication peer.

Preferably, the terminal further comprising: a second sending module, configured to send to the communication peer an acknowledge language message for acknowledging that the language type message is received.

With the present invention, during a communication process, language type currently used by the communication peer is acquired, corresponding prompt information is selected according to the language type, and the prompt information is sent to the communication peer. The problem, that corresponding language type prompt cannot be carried out according to the language type of the communication peer system during communications such as videophone and so on, is solved. It is achieved to send a video frame of the language type corresponding to the communication peer, so that the prompt between terminals with different system languages can switch automatically and the peer can be prompted by selecting corresponding prompt information according to the language type of the peer during communications such as videophone and so on, greatly improving the availability of the terminal and the user experience.

### BRIEF DESCRIPTION OF THE DRAWINGS

The drawings illustrated here provide a further understanding of the present invention and form a part of the present application. The exemplary embodiments and the description thereof are used to explain the present invention without unduly limiting the scope of the present invention, wherein:

FIG. 1 is a flowchart of a method for sending prompt information according to an embodiment of the present invention;

FIG. 2 is a preferred flowchart of a method for sending prompt information according to an embodiment of the present invention;

FIG. 3 is a flowchart of system prompt information exchange between terminals in a videophone according to an embodiment of the present invention;

FIG. 4 is a flowchart of system prompt information automatic exchange between terminals in a videophone according to an embodiment of the present invention;

FIG. 5 is a structural block diagram of a terminal according to an embodiment of the present invention;

FIG. 6 is a preferred structural block diagram of a terminal according to an embodiment of the present invention; and

FIG. 7 is a structural block diagram of a terminal according to a preferred embodiment of the present invention.

### DETAILED DESCRIPTION OF EMBODIMENTS

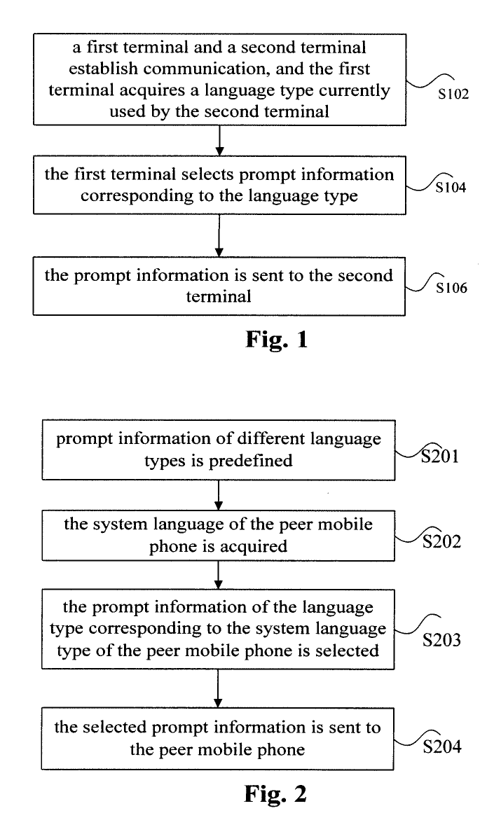

The present invention will be explained in detail hereinafter in conjunction with the drawings and the embodiments. What needs to be explained is, if there is no conflict, the embodiments of the present invention and the characters in it can be combined with each other. FIG. 1 is a flowchart of a method for sending prompt information according to an embodiment of the present invention, and as shown in FIG. 1, it comprises the following steps S102 to S106.

Step S102, a first terminal and a second terminal establish communication, and the first terminal acquires a language type currently used by the second terminal.

Step S104, the first terminal selects prompt information corresponding to the language type.

Step S106, the prompt information is sent to the second terminal.

In relevant art, during communications such as videophone and so on, if the language modes of the first terminal and the second terminal are inconsistent, it will cause the second terminal unable to understand the prompt information sent by the first terminal. In the embodiments of the present invention, the language type currently used by the second terminal can be understood by the second terminal, and the current language type of the communication peer is acquired by step S102. In step S104, corresponding prompt information can be selected according to the language type of the peer. In step S106, the prompt information of the language type corresponding to the communication peer is sent out. It can be ensured that the second terminal understands this prompt information, thus the availability of the terminal and the user experience are greatly improved.

Preferably, before step S104, the above method further comprises: the first terminal presetting prompt information of all the language types; or a user of the first terminal inputting the prompt information of all the language types into the first terminal.

For example, predefined prompt information of different language types can be prompt information strings of different language types prefabricated in a mobile phone system and can also be prompt information of different language types inputted into the mobile phone by the mobile phone user by himself/herself.

Preferably, the first terminal acquiring the language type of the second terminal in step S102 comprises: the first terminal sending a language type request message for requesting the language type and receiving a language type message carrying the language type sent by the second terminal in responsive to the language type request message; or the first terminal receiving the language type message carrying the language type actively sent by the second terminal. That is, acquiring the system language of the peer mobile phone can be of the mode of sending a request to the peer mobile phone for requesting the peer mobile phone to acquire the current system language and waiting for the response of the peer mobile phone and can also be of the mode of both of them sending their own current system languages to one another.

FIG. 2 is a flowchart of a method for sending prompt information according to an embodiment of the present invention, and as shown in FIG. 2, it comprises the following steps S201 to S204.

Step S201, prompt information of different language types is predefined.

Step S202, the system language of the peer mobile phone is acquired.

Step S203, the prompt information of the language type corresponding to the system language type of the peer mobile phone is selected.

Step S204, the selected prompt information is sent to the peer mobile phone.

With the above steps, prompting the peer by selecting corresponding prompt information according to the language type of the peer is achieved, which greatly improves the availability of the terminal and the user experience.

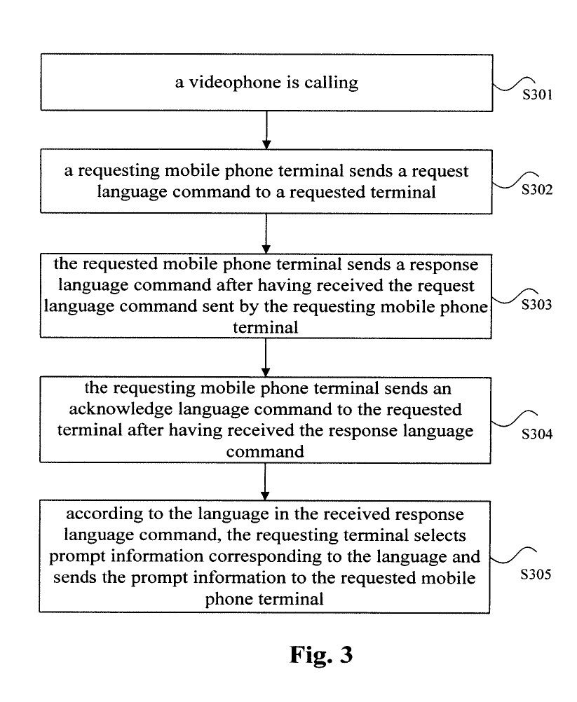

FIG. 3 is a flowchart of system prompt information exchange between terminals in a videophone communication according to an embodiment of the present invention, and as shown in FIG. 3, it comprises the following steps S301 to S305.

Step S301, a videophone is calling.

Step S302, a requesting mobile phone terminal sends a request language command (language type request message) to a requested terminal.

Preferably, in step S302, after the requesting mobile phone terminal sends the request language command, a timer can be set. If a response language command is received before the timer is overtime, then this timer can be stopped, and if the timer is overtime, the request language command can be selected to resend. A count maximum can be preset, when the counting of this resending process reaches the maximum, the resending will be stopped.

Step S303, the requested mobile phone terminal sends a response language command after having received the request language command sent by the requesting mobile phone terminal and notifies the requesting mobile phone terminal of current system prompt information of the requested mobile phone.

Preferably, after the requested mobile phone terminal sends the response language command (language type message), a timer can be set, if an acknowledge language command is received before this timer is overtime, then this timer can be stopped, and if the timer is overtime, then the acknowledge language command can be selected to resend. This resending process can be counted to a maximum, and when the counting reaches the maximum, the resending will be stopped.

Step S304, the requesting mobile phone terminal sends an acknowledge language command (acknowledge language message) to the requested terminal after having received the response language command.

Preferably, step S304 can also be omitted, and in this situation, the timer in step S303 may also not be set.

Step S305, according to the language in the received response language command, the requesting terminal selects prompt information corresponding to the language and sends the prompt information to the requested mobile phone terminal.

Preferably, selecting prompt information corresponding to the language can carry out corresponding operations according to the particular service. For example, prompt information is sent to the peer mobile phone at the beginning and ending of the video during the videophone; and prompt information for beginning to monitor is sent to the monitoring end when a circuit domain videophone is used to monitor the video, and so on.

Preferably, the request language command, the response language command and the acknowledge language command in the above steps can be implemented by using the user input indication (abbreviated as UII) in the H.245 message.

Table 1 is a command table of various prompt information according to the embodiments of the present invention, and Table 1 only gives out a command list with one encoding, here only several of them are listed for reference.

TABLE 1
Command list of prompt information

| Language encoding | Language name |
|---|---|
| ZHCN | Simplified Chinese |
| ZHTW | Traditional Chinese |
| EN | English |
| FR | French |
| GE | German |

Table 2 is a command list of requesting and responding to the prompt information of current system of the mobile phone terminal according to the embodiments of the present invention.

TABLE 2
Encoding command list

| Command encoding | Command name |
|---|---|
| REQ_LAN | Request language command |
| RES_LAN | Response language command |
| ACK_LAN | Acknowledge language command |

The request language command is REQ_LAN indicating to request the current system language of the peer mobile phone.

The response language command indicates to respond to the command for requesting the current system language sent from the requesting mobile phone terminal and notify the peer of the current system language of the present mobile phone terminal. This command is encoded by virtue of the following two modes:

Mode I: that is, “RES_LAN” is used and then the language encoding specified in Table 1 is added, for example, the response language command of simplified Chinese is: RES_LAN: ZHCN, and the response language command of English is: RES_LAN: EN.

Mode II: the language encoding specified in Table 1 is directly used as the response language command for sending, for example, the response language command of simplified Chinese is: ZHCN, and the response language command of English is: EN. The acknowledge language command is ACK_LAN for notifying the requested terminal that the response language command sent from the requested terminal has been received, and the requesting terminal may also not need to send an acknowledge language command to the requested terminal.

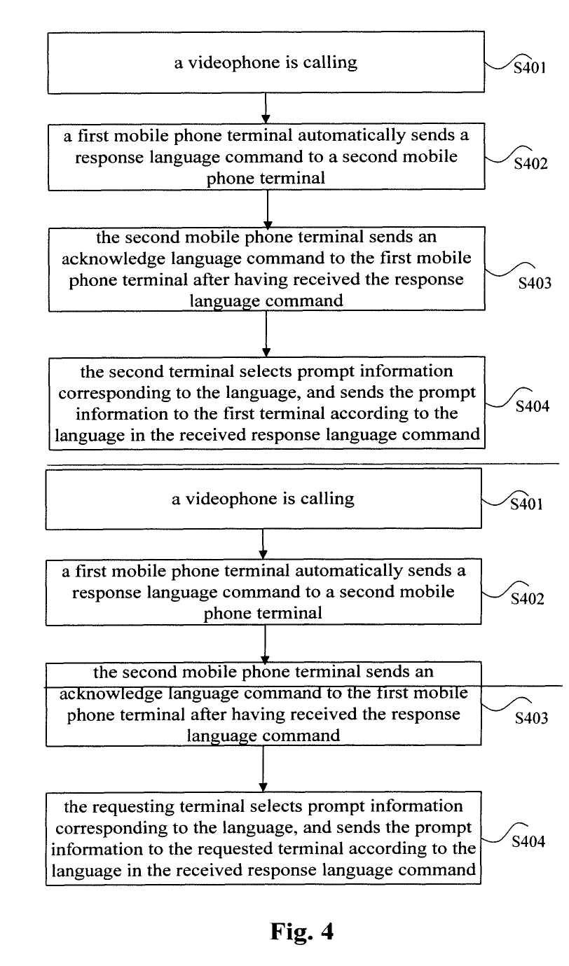

FIG. 4 is a flowchart of system prompt information automatic exchange between terminals in a videophone according to an embodiment of the present invention, and as shown in FIG. 4, it comprises the following steps S401 to S404.

Step S401, a videophone is calling.

Step S402, a first mobile phone terminal automatically sends a response language command to a second mobile phone terminal.

Preferably, step S402 can start at the time of establishing the videophone call, or can be performed before a corresponding service which needs to display prompt information during the videophone call.

Step S403, the second mobile phone terminal sends an acknowledge language command to the first mobile phone terminal after having received the response language command.

Preferably, step S403 can also be omitted.

Step S404, the requesting terminal selects prompt information corresponding to the language, and sends the prompt information to the requested terminal according to the language in the received response language command.

Preferably, selecting prompt information corresponding to the language in step S404 can carry out corresponding operations according to the particular service. For example, prompt information is sent to the peer mobile phone at the beginning and ending of the video during the videophone; and prompt information for beginning to monitor is sent to the monitoring end when a circuit domain videophone is used to monitor the video, and so on.

Preferably, the above response language command and the acknowledge language command can be implemented by using the user input indication (abbreviated as UII) in the H.245 message.

Preferably, the above response language command and the acknowledge language command can use the encoding format in Tables 1 and 2.

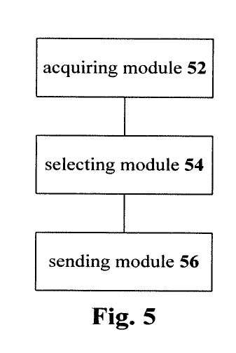

FIG. 5 is a structural block diagram of a terminal according to an embodiment of the present invention, and as shown in FIG. 5, the terminal comprises: an acquiring module 52, a selecting module 54, and a sending module 56. The above structures will be described in detail hereinafter.

The acquiring module 52 is configured to acquire a language type currently used by a communication peer; the selecting module 54, coupled to the acquiring module 52, is configured to select corresponding prompt information acquired by the acquiring module 52 according to the language type; and the sending module 56, coupled to the selecting module 54, is configured to send the prompt information selected by the selecting module 54 to the communication peer.

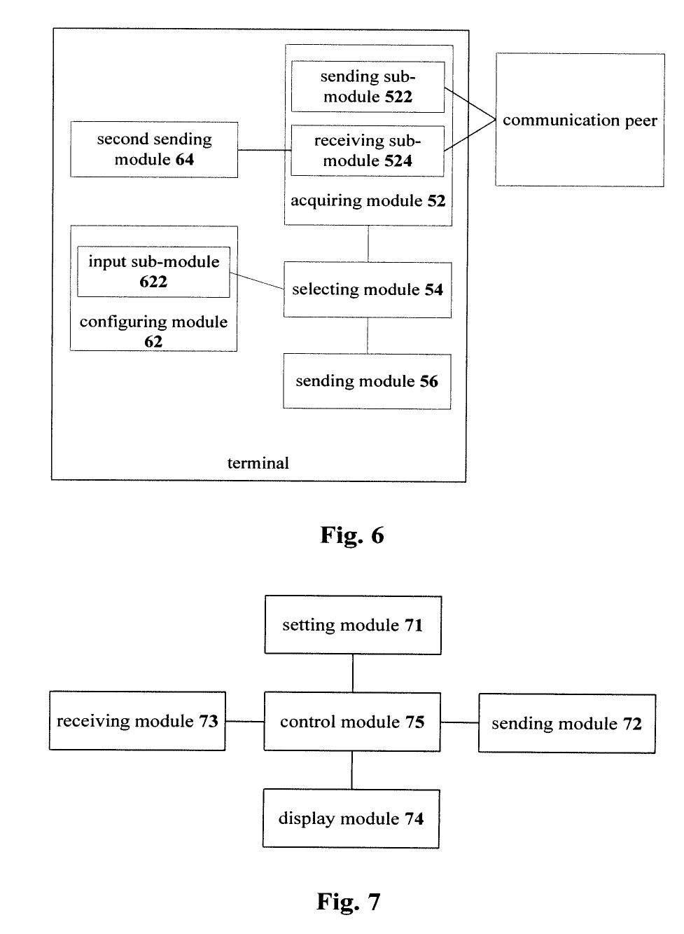

FIG. 6 is a preferred structural block diagram of the terminal according to an embodiment of the present invention, and as shown in FIG. 6, the terminal further comprises a configuring module 62, an input sub-module 622 and a second sending module 64, and the above acquiring module 52 comprises a sending sub-module 522 and a receiving sub-module 524. The above structures will be described in detail hereinafter.

The configuring module 62, coupled to the selecting module 54, is configured to preset the prompt information of all the language types so that the selecting module 54 selects a corresponding prompt information; and the input sub-module 622, coupled to the selecting module 54, is configured to input the prompt information of all the language types so that the selecting module 54 selects a corresponding prompt information.

The sending sub-module 522 is configured to send a language type request message for requesting a language type; and the receiving sub-module 524, coupled to the sending sub-module 522, is configured to receive a language type message carrying the language type sent from the communication peer. The second sending module 64, coupled to the receiving sub-module 524, is configured to send an acknowledge language message for acknowledging that the language type message is received to the communication peer after the receiving sub-module 524 has received the language type message carrying the language type sent from the communication peer.

FIG. 7 is a structural block diagram of the terminal according to a preferred embodiment of the present invention, and as shown in FIG. 7, it comprises a setting module 71, a sending module 72, a receiving module 73, a display module 74 and a control module 75, and hereinafter the above structures will be described in detail.

The setting module 71 is configured to set prompt information of different language types; the sending module 72, coupled to the control module 75, is configured to send a command for requesting the current system language of the peer mobile phone, or to send a command of the current system language to the peer mobile phone; the receiving module 73, coupled to the control module 75, is configured to receive the command for the peer mobile phone requesting the current system language of current mobile phone, or to receive the command of the current system language of the peer mobile phone sent from the peer mobile phone; the display module 74, coupled to the control module 75, is configured to display corresponding prompt information; the control module 75, coupled to the sending module 72, the receiving module 73, and the display module 74, is configured to control the sending module 72 and receiving module 73 to send and receive a corresponding command, to control the display module 74 to display, and to control the setting module to set.

What needs to be explained is, the module composition diagram according to this preferred embodiment can be widely applied in various types of terminal devices, such as mobile phone, desktop telephone, etc.

What needs to be explained is, the terminal described in the apparatus embodiments is corresponding to the above method embodiments, and its particular implementing method has been described in detail in the method embodiments, which will not be described here unnecessarily.

It can be seen from the above description that the present invention can conveniently achieve the function of automatically selecting prompt information between mobile phone terminals and makes the best use of the simplicity and being easy for modification of the user terminal software upgrading, and the telecoms operators only need to carry out suitable modification on the user terminal software (adding a corresponding service software module) to achieve the function of automatically selecting prompt information between mobile phone terminals.

Obviously, those skilled in the art shall understand that the above-mentioned modules and steps of the present invention can be realized by using general purpose calculating device, can be integrated in one calculating device or distributed on a network which consists of a plurality of calculating devices. Alternatively, the modules and the steps of the present invention can be realized by using the executable program code of the calculating device. Consequently, they can be stored in the storing device and executed by the calculating device, or they are made into integrated circuit module respectively, or a plurality of modules or steps thereof are made into one integrated circuit module. In this way, the present invention is not restricted to any particular hardware and software combination.

Above description is only to illustrate the preferred embodiments but not to limit the present invention. Various alternations and changes to the present invention are apparent to those skilled in the art. The scope defined in claims shall comprise any medication, equivalent substitution and improvement within the spirit and principle of the present invention.

1. A method for sending prompt information, comprising:
a first terminal and a second terminal establishing communication;
the first terminal acquiring a language type currently used by the second terminal; and
the first terminal selecting a corresponding prompt information according to the language type and sending the prompt information to the second terminal.

2. The method according to claim 1, wherein before the first terminal acquiring the language type currently used by the second terminal, the method further comprises:
the first terminal presetting prompt information of all the language types.

3. The method according to claim 2, wherein the first terminal presetting the prompt information of all the language types comprises:
a user of the first terminal inputting the prompt information of all the language types into the first terminal.

4. The method according to claim 1, wherein the first terminal acquiring the language type of the second terminal comprises:
the first terminal sending a language type request message for requesting the language type and receiving a language type message carrying the language type sent by the second terminal in responsive to the language type request message; or
the first terminal receiving the language type message carrying the language type actively sent by the second terminal.

5. The method according to claim 4, wherein after the first terminal sending a language type request message, the method further comprises:
the first terminal resending the language type request message in the situation that the language type message is not received within a preset time period.

6. The method according to claim 4, wherein after the first terminal receiving the language type message, the method further comprises:
the first terminal sending to the second terminal an acknowledge language message for acknowledging that the language type message is received.

7. The method according to claim 6, wherein the language type request message, the language type message and the acknowledge language message are implemented by the H.245 protocol.

8. A terminal, comprising:
an acquiring module, configured to acquire a language type currently used by a communication peer;
a selecting module, configured to select corresponding prompt information according to the language type; and
a sending module, configured to send the prompt information to the communication peer.

9. The terminal according to claim 8, wherein
the terminal further comprises:
a configuring module, configured to preset prompt information of all the language types; and
the configuring module comprises:
an input sub-module, configured to input the prompt information of all the language types.

10. The terminal according to claim 8, wherein the acquiring module comprises:
a sending sub-module, configured to send a language type request message for requesting the language type; and
a receiving sub-module, configured to receive a language type message carrying the language type sent by the communication peer.

11. The terminal according to claim 10, further comprising:
a second sending module, configured to send to the communication peer an acknowledge language message for acknowledging that the language type message is received.
